(19) United States
(12) Patent Application Publication
(10) Pub. No.: US 2026/0221701 A1
(43) Pub. Date: Jul. 30, 2026

(54) CONNECTOR, FITTING OPENING, AND ATTACHMENT MEMBER

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Ryo MARUI, Osaka (JP); Kenya TAKAHASHI, Mie (JP)

(21) Appl. No.: 19/146,225

(22) PCT Filed: Jan. 20, 2023
(86) PCT No.: PCT/JP2023/001746

§ 371 Date: Jul. 8, 2025

(51) Int. Cl. H01R 13/74; B60L 53/16

(52) U.S. Cl. CPC H01R 13/74; B60L 53/16; H01R 2201/26

(57) ABSTRACT

This connector includes a fitting opening for charging, and an attachment part for attaching the fitting opening to a vehicle. The attachment part includes: a panel part having a first surface and a second surface, with an opening being formed between the first and second surfaces; and a flange part having an attachment implement for attaching the panel part to the vehicle, the flange part being formed around the panel part. The fitting opening includes a tubular housing that encompasses, in the interior thereof, a terminal group for charging. The housing has an abutment part that abuts the second-surface-side peripheral edge part of the opening so that the distal end of the housing is at a position having a prescribed relationship with the first surface when the housing is fitted into the opening from the second-surface side.

### TECHNICAL FIELD

The present disclosure relates to a connector, a fitting opening and an attachment member.

### BACKGROUND

The spread of electric vehicles is in progress worldwide. In an electric vehicle, a storage battery needs to be charged according to need to drive the vehicle. A facility therefor is necessary. Since the installation of a charging facility, which has been a key to the spread of electric vehicles, is in progress, the spread of electric vehicles is thought to accelerate in the future.

In charging an electric vehicle using a charging facility, hardware necessary for charging needs to be made common to vehicles of any car manufacturer so that the respective vehicles can utilize a common charging facility. Standards therefor are provided. Each vehicle is provided with a connector serving as a charging port suited to the standards. Such connectors are not manufactured by car manufacturers, but companies manufacturing connectors generally deliver the connectors to each car manufacturer.

On the other hand, there are many car manufacturers in the world and each car manufacturer manufactures and sells vehicles having various vehicle bodies. Thus, there is a problem that cost increases if connectors are manufactured according to each of those vehicles. Particularly, it is anticipated that manufacturers in various fields participate in the manufacturing of automotive vehicle components including connectors, and it is required to reduce the cost of connectors conforming to necessary standards while keeping necessary strength.

One proposal for solving such a problem is disclosed in Patent Document 1. A connector disclosed in Patent Document 1 includes a housing divided for a vehicle body attachment portion and a connector body portion. The vehicle body attachment portion includes a hollow cylindrical outer tube portion, and the connector body portion is fit into this outer tube portion. The connector body portion is common to any vehicle and the vehicle body attachment portion is shaped to conform to the vehicle.

### PRIOR ART DOCUMENT

### Patent Document

Patent Document 1: JP 2018-026287 A

### SUMMARY OF THE INVENTION

### Means to Solve the Problem

One aspect of the present disclosure is directed to a connector with a fitting opening for charging and an attachment portion for attaching the fitting opening to a vehicle, the attachment portion including a panel portion having a first surface and a second surface, the panel portion being formed with an opening between the first and second surfaces, and a flange portion having an attachment tool for attaching the panel portion to the vehicle, the flange portion being formed around the panel portion, the fitting opening including a tubular housing including a terminal group for charging inside, and the housing including a contact portion for contacting a peripheral edge part of the opening on the second surface side such that a tip of the housing is in a predetermined positional relationship with the first surface when the housing is fit into the opening from the second surface side.

The above and other objects, features, aspects and advantages of this disclosure will become apparent from the following detailed description relating to this disclosure to be understood in relation to the attached drawings.

### BRIEF DESCRIPTION OF THE DRAWINGS

FIG. 1 is a perspective view of a connector according to a first embodiment of this disclosure before being assembled.

FIG. 2 is a perspective view of the assembled connector according to the first embodiment of this disclosure.

FIG. 3 is a perspective view of the assembled connector when viewed from a back side.

FIG. 4 is a perspective view of an attachment member of the connector to a vehicle.

FIG. 5 is a perspective view of the attachment member 60 of the connector according to the first embodiment when viewed from the back side.

FIG. 6 is a front view of the attachment member.

FIG. 7 is a section along 7-7 of FIG. 6.

FIG. 8 is a partial enlarged view of FIG. 7.

FIG. 9 is a partial enlarged view of FIG. 7.

FIG. 10 is a front view of a fitting opening of the connector according to the first embodiment.

FIG. 11 is a section along 11-11 of FIG. 10.

FIG. 12 is a partial enlarged view of FIG. 11.

FIG. 13 is a partial enlarged view of FIG. 11.

FIG. 14 is a front view of the assembled connector 50.

FIG. 15 is a section along 15-15 of FIG. 14.

FIG. 16 is a partial enlarged view of FIG. 15.

FIG. 17 is a partial enlarged view of FIG. 15.

FIG. 18 is a perspective view of a connector according to a second embodiment of this disclosure before being assembled.

FIG. 19 is a perspective view of the assembled connector according to the second embodiment of this disclosure.

FIG. 20 is a perspective view of the assembled connector when viewed from a back side.

FIG. 21 is an enlarged view of a part of an attachment member shown in FIG. 18.

FIG. 22 is a perspective view of the attachment member of the connector to a vehicle when viewed from the back side.

FIG. 23 is an enlarged view of a part of FIG. 22.

FIG. 24 is a perspective view of a fitting opening according to the second embodiment of this disclosure.

FIG. 25 is a perspective view of the fitting opening when viewed from an angle different from that in FIG. 24.

FIG. 26 is a front view of the attachment member.

FIG. 27 is a section along 27-27 of FIG. 26.

FIG. 28 is an enlarged view of a partial region of FIG. 27.

FIG. 29 is an enlarged view of a partial region of FIG. 27.

FIG. 30 is a section along 30-30 of FIG. 26.

FIG. 31 is an enlarged view of a partial region of FIG. 30.

FIG. 32 is an enlarged view of a partial region of FIG. 30.

FIG. 33 is a front view of the fitting opening.

FIG. 34 is a section along 34-34 of FIG. 33.

FIG. 35 is a partial enlarged view of FIG. 34.

FIG. 36 is a partial enlarged view of FIG. 34.

FIG. 37 is a section along 37-37 of FIG. 33.

FIG. 38 is a partial enlarged view of FIG. 37.

FIG. 39 is a partial enlarged view of FIG. 37.

FIG. 40 is a front view of the connector when the fitting opening is assembled with the attachment member.

FIG. 41 is a section along 41-41 of FIG. 40.

FIG. 42 is a partial enlarged view of FIG. 41.

FIG. 43 is a partial enlarged view of FIG. 41.

FIG. 44 is a section along 44-44 of FIG. 40.

FIG. 45 is a partial enlarged view of FIG. 44.

FIG. 46 is a partial enlarged view of FIG. 44.

### DETAILED DESCRIPTION TO EXECUTE THE INVENTION

### Technical Problem

In a technique disclosed in Patent Document 1, the connector is shaped such that the connector body portion is passed through the outer tube portion and the entire inner peripheral surface of the outer tube portion is held in close contact with the outer peripheral surface of the connector body portion. However, if such a configuration is adopted, assemblability is thought to be deteriorated in inserting the connector body portion into the outer tube portion.

This disclosure aims to provide a connector, a fitting opening and an attachment member, which enable easy assembly of components.

### Effects of this Disclosure

As described above, according to this disclosure, it is possible to provide a connector, a fitting opening and an attachment member, which enable easy assembly of components.

### DESCRIPTION OF EMBODIMENTS OF PRESENT DISCLOSURE

In the following description and drawings, the same components are denoted by the same reference numbers. Accordingly, those are not repeatedly described in detail. Note that at least some of embodiments described below may be arbitrary combined.

(1) A connector according to a first aspect of the present disclosure may be provided with a fitting opening for charging and an attachment portion for attaching the fitting opening to a vehicle, the attachment portion including a panel portion having a first surface and a second surface, the panel portion being formed with an opening between the first and second surfaces, and a flange portion having an attachment tool for attaching the panel portion to the vehicle, the flange portion being formed around the panel portion, the fitting opening including a tubular housing including a terminal group for charging inside, and the housing including a contact portion for contacting a peripheral edge part of the opening on the second surface side such that a tip of the housing is in a predetermined positional relationship with the first surface when the housing is fit into the opening from the second surface side. By this configuration, components are easily assembled.

(2) In (1) described above, the peripheral edge part of the opening on the second surface side is chamfered in the panel portion. By this configuration, the housing is easily fit into the opening of the panel portion.

(3) In (1) or (2) described above, a predetermined region adjacent to the contact portion from the tip side of the housing is formed to have a taper larger than a taper from the predetermined region to the tip of the housing on an outer peripheral surface of the housing. By this configuration, the components are easily assembled.

(4) In (1) or (2) described above, a step is formed at a position separated from the contact portion toward the tip side by a predetermined distance on an outer peripheral surface of the housing. By this configuration, the components are easily assembled and the fitting opening is also easily positioned.

(5) In (3) described above, an inner periphery of the opening in the panel portion is shaped to have such a taper that an inner diameter of the opening increases from the first surface toward the predetermined region. By this configuration, the components are easily assembled.

(6) In any one of (1) to (5) described above, the connector may be further provided with three or more housing-side crush ribs formed in a predetermined region extending from the tip side of the housing and in contact with the contact portion on an outer periphery surface of the housing. By this configuration, the components are easily assembled and the fitting opening is also easily positioned.

(7) In (6) described above, the connector may include four or more of the housing-side crush ribs. By this configuration, the components are easily assembled and the fitting opening is also easily positioned.

(8) In (6) or (7) described above, the housing has a center axis in a direction coinciding with an insertion direction of the housing into the opening, and the three or more housing-side crush ribs are formed at rotationally symmetrical positions with respect to the center axis. By this configuration, the components are easily assembled and the fitting opening is also easily positioned.

(9) In any one of (6) to (8) described above, the three or more housing-side crush ribs are formed at line symmetrical positions. By this configuration, the assembly of the components and the positioning of the fitting opening are facilitated.

(10) In any one of (1) to (4) described above, the connector may be further provided with three or more panel-side crush ribs formed in a region closer to the first surface than the second surface on an inner peripheral surface of the opening of the panel portion. By this configuration, the components are easily assembled and the fitting opening is also easily positioned.

(11) In (10) described above, the connector may include four or more of the housing-side crush ribs. By this configuration, the components are easily assembled and the fitting opening is also easily positioned.

(12) In (10) or (11) described above, the housing has a center axis in a direction coinciding with an insertion direction of the housing into the opening, and the three or more panel-side crush ribs are formed at rotationally symmetrical positions with respect to the center axis of the housing when the housing is fit into the opening. By this configuration, the components are easily assembled and the fitting opening is also easily positioned.

(13) In (10) or (11) described above, the three or more panel-side crush ribs are formed at line symmetrical positions. By this configuration, the components are easily assembled and the fitting opening is also easily positioned.

(14) In any one of (1) to (5) described above, the connector may be further provided with three or more housing-side crush ribs formed in a predetermined region extending from the tip side of the housing and in contact with the contact portion on an outer peripheral surface of the housing and three or more panel-side crush ribs formed in a region closer to the first surface than the second surface on an inner peripheral surface of the opening of the panel portion, and at least one of the three or more housing-side crush ribs and at least one of the three or more panel-side crush ribs are formed at positions not to interfere with each other so that these crush ribs are opposed to each other when the fitting opening is fit into the opening. By this configuration, the components are easily assembled and the fitting opening is also easily positioned.

(15) A fitting opening according to a second aspect of this disclosure is a component of a connector to be attached to a vehicle, the connector including the fitting opening and an attachment portion for attaching the fitting opening to the vehicle, the attachment portion including a panel portion having a first surface and a second surface, the panel portion being formed with an opening between the first and second surfaces, and a flange portion having an attachment tool for attaching the panel portion to the vehicle, the flange portion being formed around the panel portion, the fitting opening being provided with a tubular housing including a terminal group for charging inside, the housing including a contact portion for contacting a peripheral edge part of the opening on the second surface side such that a tip of the housing is in a predetermined positional relationship with the first surface when the housing is fit into the opening from the second surface side, and a predetermined region adjacent to the contact portion from the tip side of the housing being formed to have a taper larger than a taper from the predetermined region to the tip of the housing on an outer peripheral surface of the housing. By this configuration, components are easily assembled.

(16) An attachment member according to a third aspect of this disclosure is for attaching a fitting opening for charging to a vehicle, and provided with a panel portion having a first surface and a second surface, the panel portion being formed with an opening between the first and second surfaces, and a flange portion having an attachment tool for attaching the panel portion to the vehicle, the flange portion being formed around the panel portion, a peripheral edge part of the opening on the second surface side being chamfered. By this configuration, components are easily assembled.

### DESCRIPTION OF EMBODIMENTS OF PRESENT DISCLOSURE

Specific examples of a connector, a fitting opening and an attachment member according to embodiments of the present disclosure are described below with reference to the drawings. Note that the present disclosure is not limited to these illustrations, but is represented by claims and intended to include all changes in the scope of claims and in the meaning and scope of equivalents.

### 1. First Embodiment

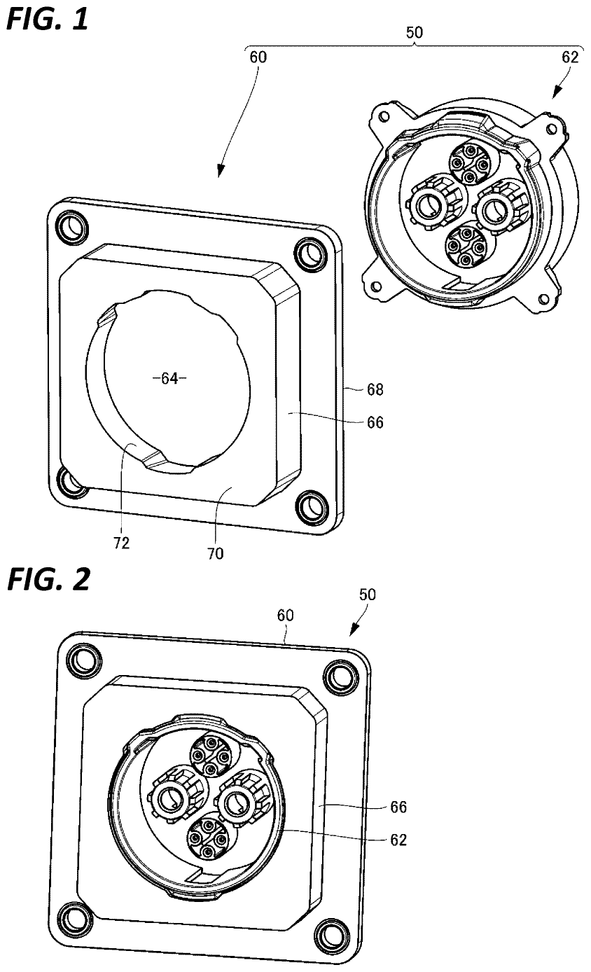

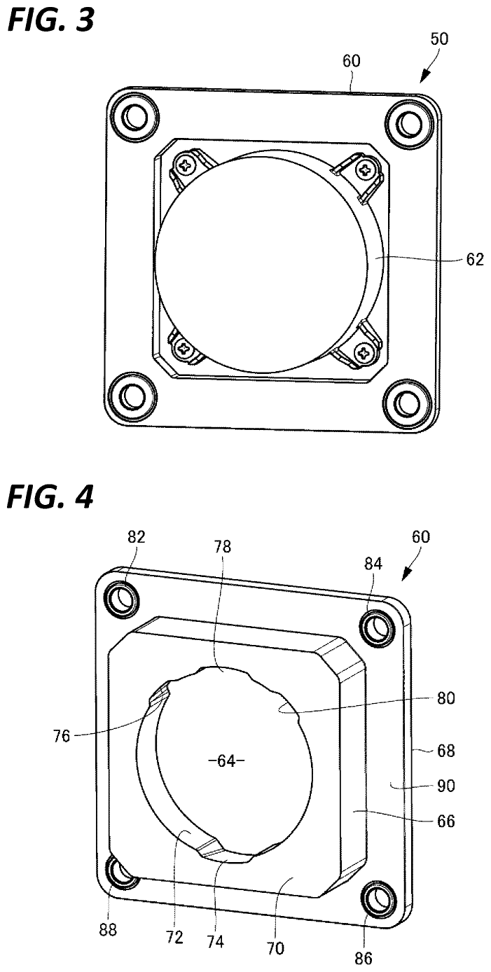

FIG. 1 shows a perspective view of a connector 50 according to a first embodiment of this disclosure before an attachment member 60 and a fitting opening 62 are assembled. FIG. 2 shows a perspective view of the connector 50 after the attachment member 60 and the fitting opening 62 are assembled. FIG. 3 is a view of the connector 50 shown in FIG. 2 when viewed from a back side. As shown in FIGS. 1, 2 and 3, the connector 50 includes the attachment member 60 and the fitting opening 62 both made of insulating resin.

### 1-1. Attachment Member 60

The attachment member 60 includes a panel portion 66 having a rectangular parallelepiped shape and having a substantially square front surface 70. The panel portion 66 includes an opening 64, into the fitting opening 62 is fit. The outer periphery of the opening 64 is substantially circular and defined by an inner peripheral surface 72 of the panel portion 66. The attachment member 60 further includes a flange 68 formed around the panel portion 66 on a side opposite to the front surface 70. The flange 68 includes an attachment tool for attaching the attachment member 60 to a vehicle. The fitting opening 62 has a substantially hollow cylindrical shape. As shown in FIGS. 2 and 3, a front part of the fitting opening 62 is fit into the opening 64 from the back side.

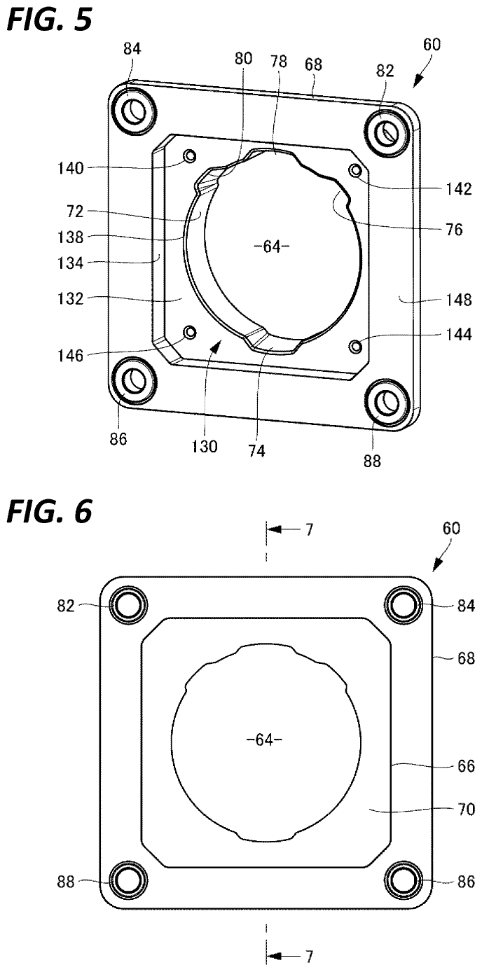

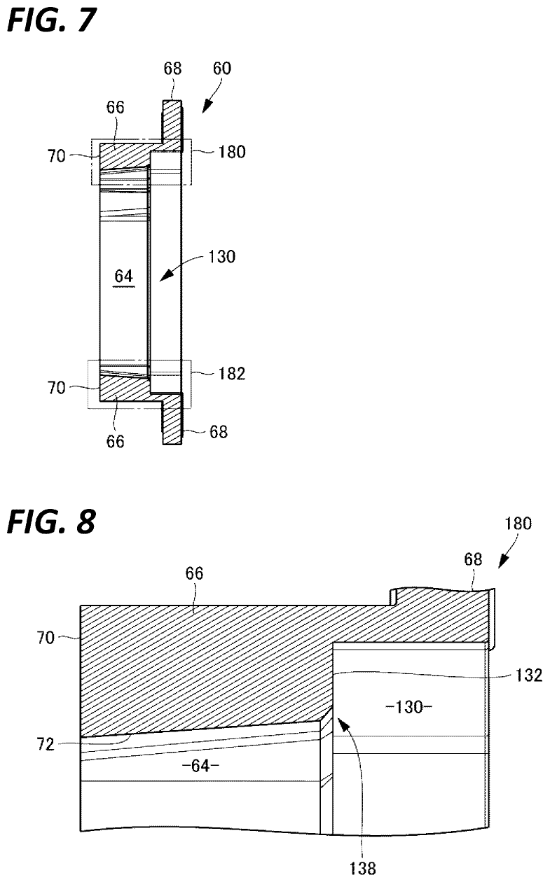

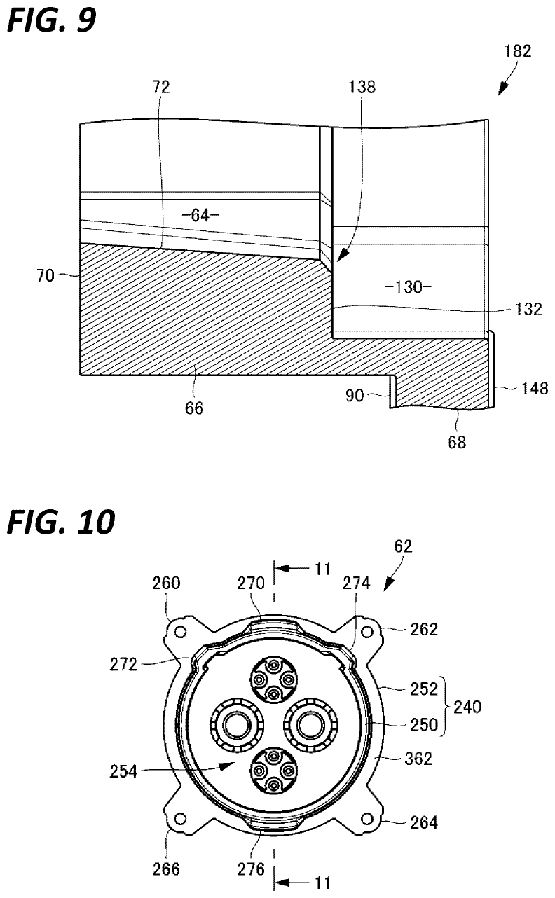

FIG. 4 is a perspective view of the attachment member 60 when viewed from front, and FIG. 5 is a perspective view of the attachment member 60 when viewed from behind. FIG. 6 is a front view of the attachment member 60. FIG. 7 is a section along 7-7 of FIG. 6. FIG. 8 is an enlarged view of a region 180 of FIG. 7, and FIG. 9 is an enlarged view of a region 182 of FIG. 7. With reference to FIGS. 4, 5, 6, 7, 8 and 9, the detailed shape of the attachment member 60 is described.

Particularly with reference to FIGS. 4 and 5, the attachment member 60 includes the rectangular parallelepiped-shaped panel portion 66 having the substantially square front surface 70 and the flange 68 provided on a back side of the panel portion 66 as described above. The panel portion 66 is formed with the substantially circular opening 64. The outer periphery of the opening 64 is substantially circular, but the inner peripheral surface 72 thereof is formed with recesses 74, 76, 78 and 80, into which protrusions formed on the outer periphery of the front part of the fitting opening 62 are inserted.

The flange 68 also has a square shape with four rounded corners. Attachment holes 82, 84, 86 and 88, into which screws are inserted to attach the attachment member 60 to a vehicle body, are provided in the four corners of the flange 68. In this embodiment, a front surface 90 of the flange 68 is parallel to the front surface 70.

With reference to FIGS. 5, 7, 8 and 9, an opening 130 larger than the opening 64 and having a substantially square shape is formed in a back surface 148 of the panel portion 66. The periphery of the opening 130 is defined by a side surface 134. A deepest part of the opening 130 forms a bottom surface 132. The opening 64 is open on the back side in the bottom surface 132. A chamfered portion 138 is formed on a corner part of a boundary part of the opening 64. Since the chamfered portion 138 is present, an operation of inserting the fitting opening 62 into the opening 64 can be smoothly performed, assembly is facilitated and work efficiency is improved. Further, four corners of the opening 130 are chamfered, and screw holes 140, 142, 144 and 146 for fixing the fitting opening 62 are formed in the bottom surface 132 near the four corners.

### 1-2. Fitting Opening 62

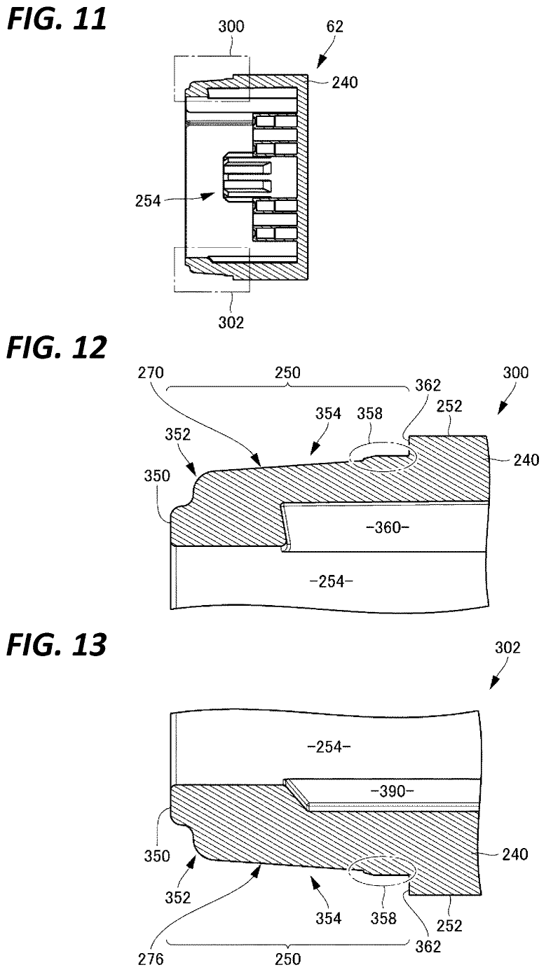

FIG. 10 is a front view of the fitting opening 62, and FIG. 11 is a section along 11-11 of FIG. 10. FIG. 12 is an enlarged view of a region 300 of FIG. 11, and FIG. 13 is an enlarged view of a region 302 of FIG. 11. With reference to FIGS. 10, 11, 12 and 13, the fitting opening 62 includes a housing 240. The housing 240 includes a hollow cylindrical fitting portion 250 having a space 254 including a plurality of electrode terminals (terminal group) for charging and a rear housing 252 connected to a tail of the fitting portion 250 and having a radius one size larger than the fitting portion 250. An outer side of the fitting portion 250 forms a contact surface 362 in a connected part of the fitting portion 250 and the rear housing 252. The contact surface 362 prevents the fitting opening 62 from moving to the inside of the opening 64 any further by contacting the bottom surface 132 shown in FIGS. 8 and 9 when the fitting opening 62 is inserted into the opening 64 of the attachment member 60. By the function of the contact surface 362, a tip part of the fitting opening 62 is substantially flush with the front surface 70 of the attachment member 60 when the fitting opening 62 is fit into the opening 64 of the attachment member 60.

Further, protruding portions 260, 262, 264, 266 are provided in parts in contact with the contact surface 362 at four surrounding positions of the rear housing 252. Each of these protruding portions is formed with an opening. Screws are inserted into these openings and screwed into screw holes 140, etc. shown in FIG. 5, whereby the fitting opening 62 is fixed to the attachment member 60.

Note that an outer peripheral part of the fitting portion 250 is substantially circular, but protrusions 270, 272, 274 and 276 are formed in predetermined parts. These are determined by standards, and so positioned that a charging-side plug is correctly connected to the attachment member 60 during charging. Spaces are formed inside these protrusions. Particularly, the protrusion 276 present in a lower part functions to collect water and the like having intruded into the space 254 in rainy weather or the like and discharge those to outside. As shown in FIGS. 4, 5 and 6, the recesses 78, 76, 80 and 74 are formed at positions corresponding to the protrusions 270, 272, 274 and 276. The shape of the inner peripheral surface 72 defining the periphery of the opening 64 including these is substantially at a contraposition of the outer periphery of the fitting portion 250 of the fitting opening 62. However, the attachment member 60 and the fitting opening 62 are so formed that a radius of the inner peripheral surface 72 is slightly larger than that of the fitting portion 250. By engaging the protrusions such as the protrusion 270 with the recess 78 and the like, both side surfaces of the protrusion 270 and the like are in contact with both side surfaces of the recess 78 and the fitting opening 62 is prevented from turning inside the opening 64.

FIG. 12 is a section of a part of the protrusion 270 shown in FIG. 10. As shown in FIG. 12, the fitting portion 250 is continuously formed on the tip of the rear housing 252. A space 360 communicating with the space 254 is formed inside the protrusion 270. An upper part of the fitting portion 250 is raised to be higher than other parts due to the protrusion 270 and has a tip surface 350, a tip part side surface 352 and a side surface 354. The side surface 354 is formed to spread from a tip side of the fitting portion 250 while having a fixed taper, i.e. gradually increase an outer diameter of the fitting portion 250. The side surface 354 has a slightly steeper taper in a region 358 in contact with the contact surface 362 of the rear housing 252, whereby a step is formed. This step is much smaller than an outer peripheral part of the fitting portion 250. This step is formed not only in the part of the protrusion 270, but over the entire periphery of the fitting portion 250.

FIG. 13 is a section of a part of the protrusion 276 of FIG. 10. With reference to FIG. 13, a space 390 communicating with the space 254 is formed inside the protrusion 276 also in this part. The space 390 has a drainage port (not shown) leading to the outside of the housing 240. Also in this part, the fitting portion 250 has a tip surface 350, a tip part side surface 352 and a side surface 354 spreading outward while having a fixed taper. As in FIG. 12, a part having a steeper taper than other parts of the side surface 354 is formed in the region 358 adjacent to the contact surface 362, out of the side surface 354. A step much smaller than the outer peripheral part of the fitting portion 250 is formed in the region 358.

### 1-3. During Assembly

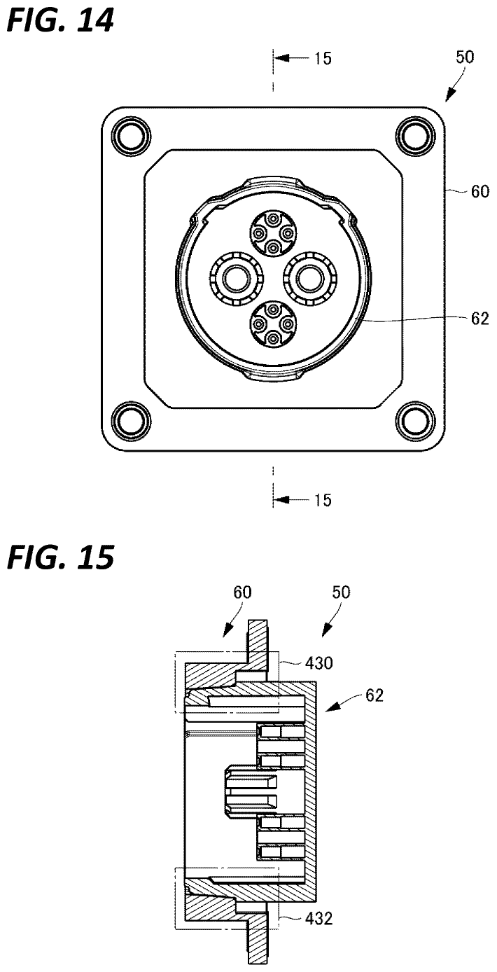

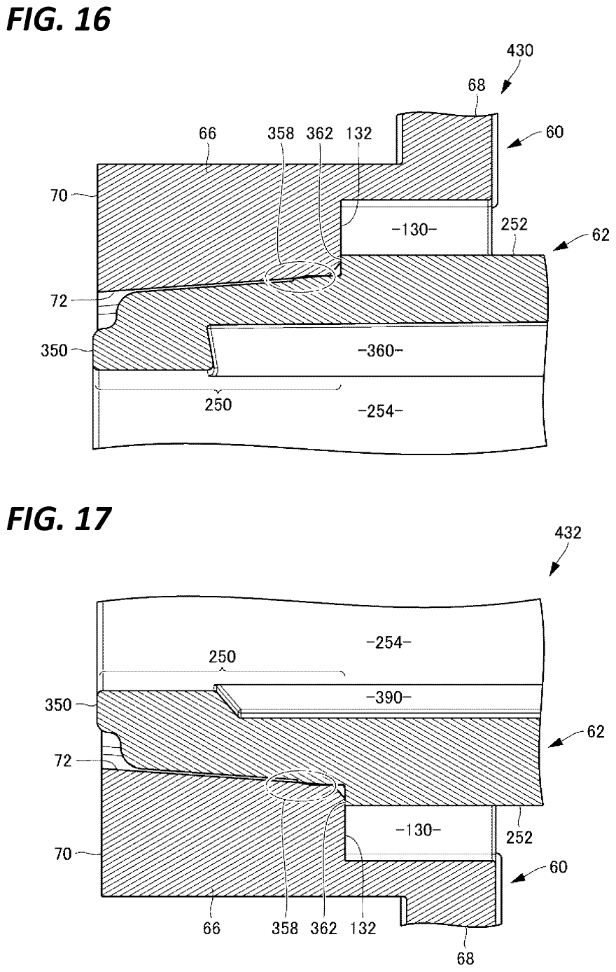

FIG. 14 is a front view of the connector 50 obtained by assembling the fitting opening 62 with the attachment member 60, and FIG. 15 is a section along 15-15 of FIG. 14. FIG. 16 is an enlarged view of a region 430 in FIG. 15, and FIG. 17 is an enlarged view of a region 432 in FIG. 15.

With reference to FIGS. 14 to 17, particularly FIGS. 16 and 17, since the chamfered portion 138 is formed on the boundary between the bottom surface 132 of the attachment member 60 and the inner peripheral surface 72 as already described above, the fitting opening 62 can be easily inserted into the opening 64 when the fitting opening 62 is fit into the opening 64 of the attachment member 60. As a result, work efficiency is improved. Further, as described above, the contact surface 362 of the rear housing 252 contacts the bottom surface 132 of the attachment member 60 to position the fitting opening 62 in the front-rear direction. As a result, the fitting opening 62 is so assembled with the attachment member 60 that the front surface 70 of the attachment member 60 and the tip surface 350 of the fitting opening 62 are substantially flush with each other. Further, in the part of the region 358, the inner peripheral surface 72 of the panel portion 66 and a step part of the region 358 on the outer peripheral part of the fitting portion 250 are fit to each other, thereby radially positioning the fitting opening 62 in the opening 64. In this embodiment, the step part of the region 358 is formed over the entire outer periphery of the fitting portion 250, and the fitting portion 250 of the fitting opening 62 is correctly positioned in a central part of the opening 64. Further, in this embodiment, a very tiny gap is formed between the inner peripheral surface 72 of the attachment member 60 and the side surface 354 of the fitting portion 250 on a side closer to the tip than the region 358. For example, in a configuration in which illumination is provided behind the fitting opening 62 to indicate that charging is in progress during charging, light equally leaks forward of the connector through this gap, whereby functional and aesthetic effects can also be achieved.

Note that, although the step is formed over the entire periphery of the fitting portion 250 in this embodiment, this disclosure is not limited to such an embodiment. Steps may be formed only in parts around the fitting portion 250. In that case, to correctly position the fitting opening 62 and the attachment member 60, the steps are desirably provided at positions to be symmetrical with respect to a vertical or lateral center line of the opening 64 or to be rotationally symmetrical with a center axis in the front-rear direction of the opening 64 as a center of rotation.

Further, in this embodiment, a step portion such as the region 358 is formed on the outer part of the fitting portion 250. However, this disclosure is not limited to such an embodiment. Conversely, a step may be provided to reduce an inner diameter of the opening 64 in a region adjacent to the chamfered portion 138 inside the opening 64.

### 2. Second Embodiment

In the above first embodiment, the step is provided over the entire outer peripheral part of the fitting portion 250. However, this disclosure is not limited to the embodiment in which the step is provided on the outer peripheral part of the fitting portion 250 or on the inner peripheral part of the opening 64 of the attachment member 60. Rather than providing the step as a surface, projections having a proper size, e.g. crush ribs, may be formed at proper positions. This second embodiment is such an example.

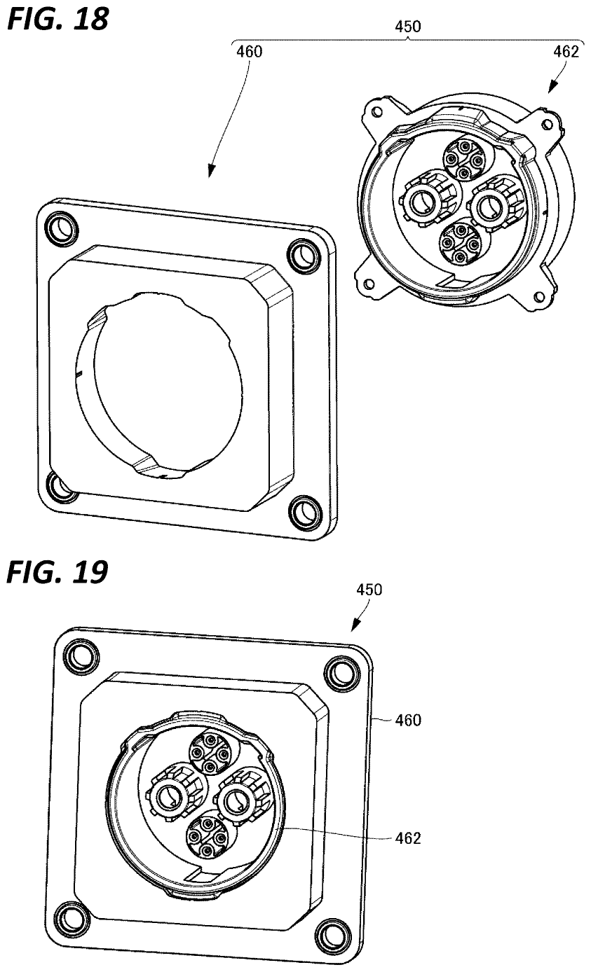

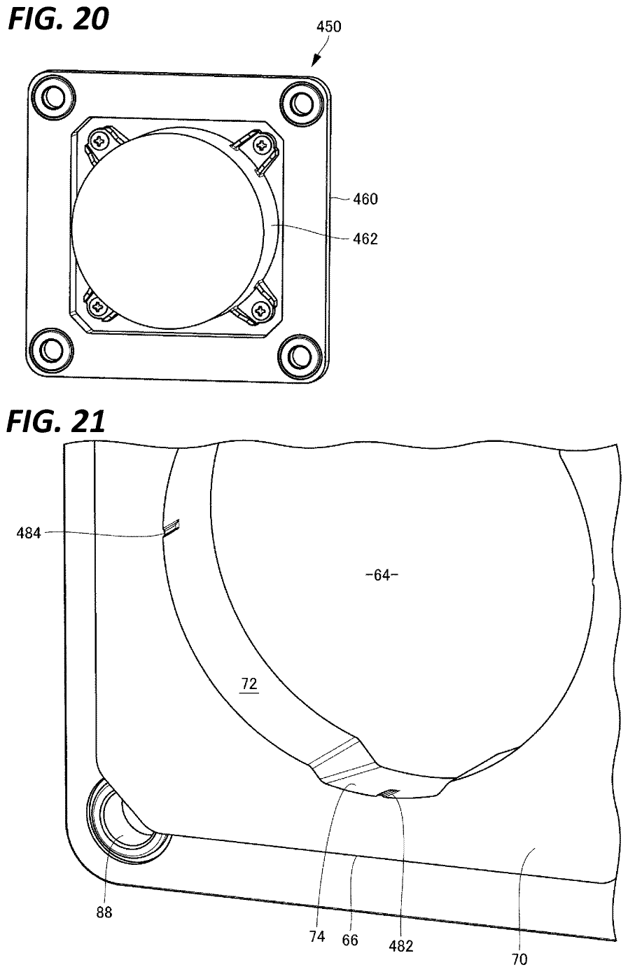

With reference to FIGS. 18, 19 and 20, a connector according to the second embodiment includes an attachment member 460 having an opening 64 and a fitting opening 462 to be fit into the opening 64 of the attachment member 460. The attachment member 460 and the fitting opening 462 are substantially the same as the attachment member 60 and the fitting opening 62 according to the first embodiment, but are characterized in that crush ribs are provided in parts of the outer periphery of the fitting opening 462 and parts of the inner periphery of the opening 64, instead of the step provided on the outer periphery of the fitting opening 62 in the first embodiment, as described later.

### 2-1. Attachment Member 460

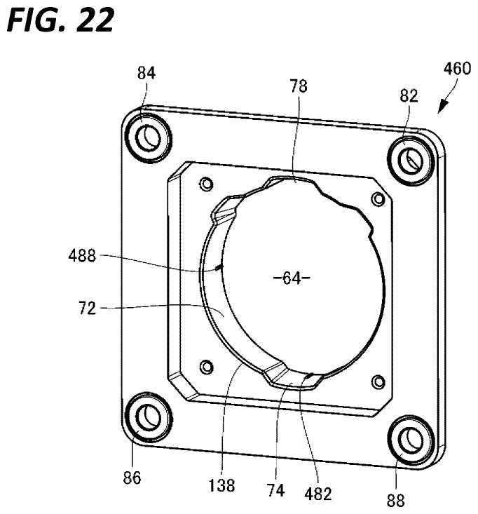

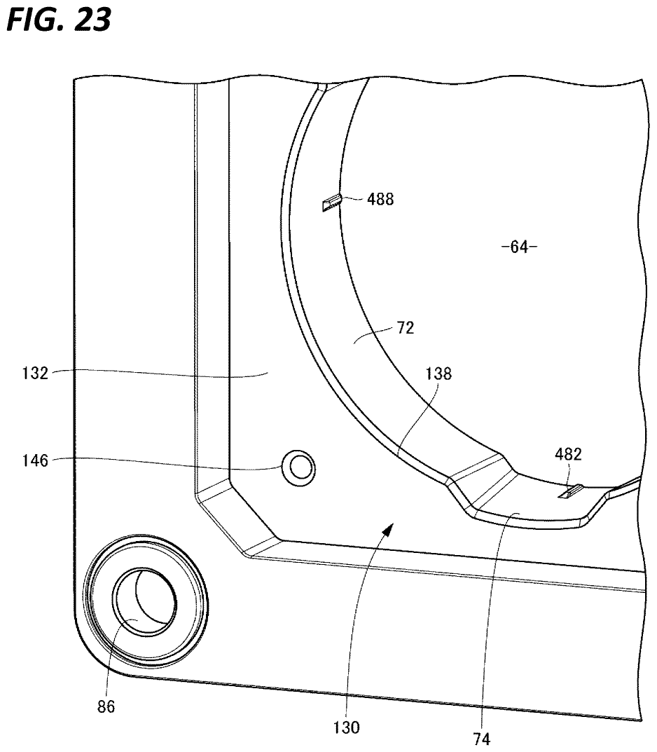

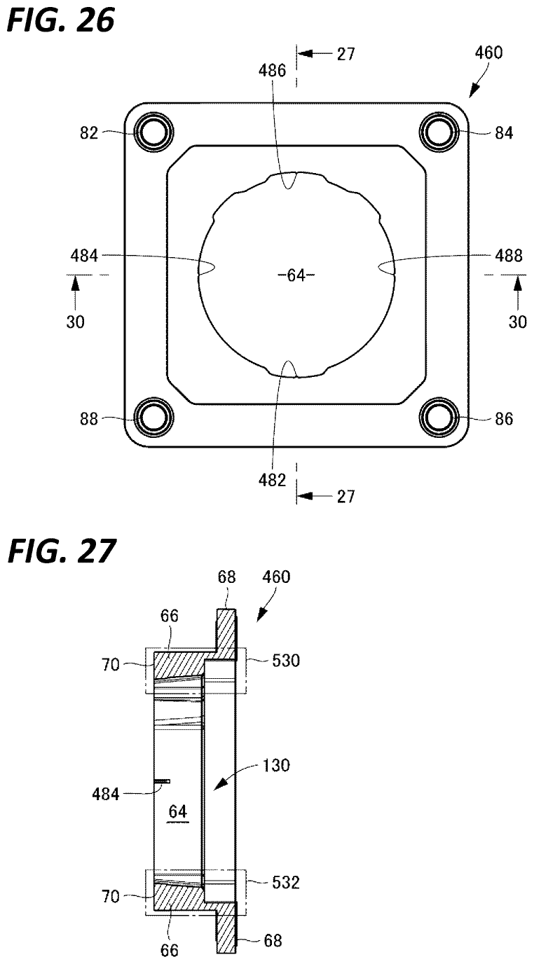

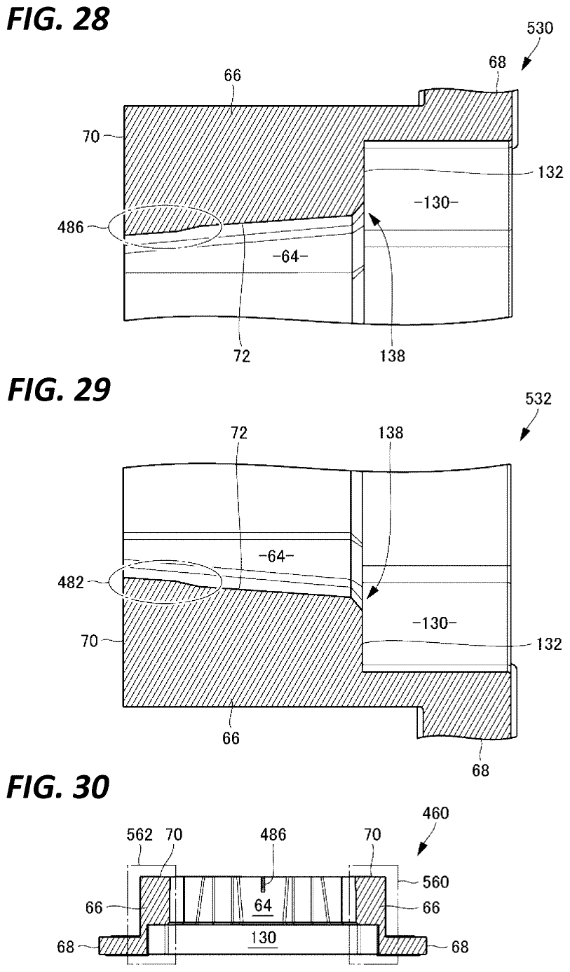

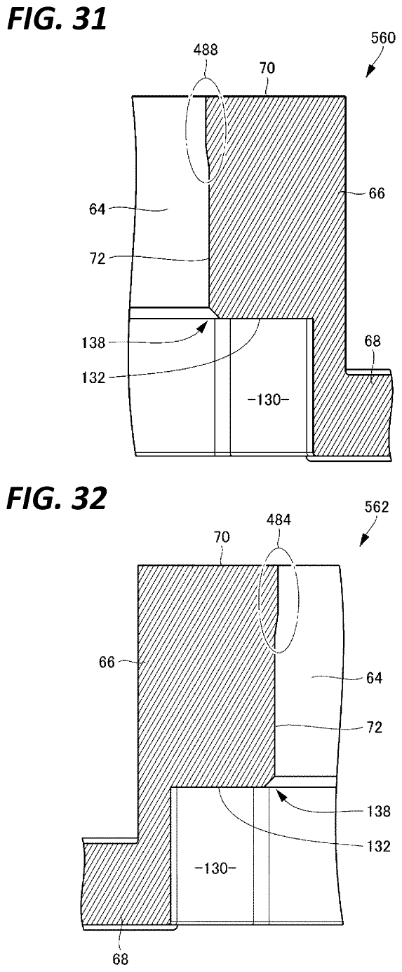

FIG. 21 is an enlarged view of a part of the attachment member 460 shown in FIG. 18. FIG. 22 shows a back surface of the attachment member 460, and FIG. 23 is an enlarged view of a part of FIG. 22. Further, FIG. 26 is a plan view of the attachment member 460. FIG. 27 is a section along 27-27 of FIG. 26. FIG. 28 is an enlarged view of a region 530 of FIG. 27, and FIG. 29 is an enlarged view of a region 532 of FIG. 27. Further, FIG. 30 is a section along 30-30 of FIG. 26. FIG. 31 is an enlarged view of a region 560 of FIG. 30, and FIG. 32 is an enlarged view of a region 562 of FIG. 30.

With reference to FIGS. 1, 21, 22, 23, 26, 27 and 28, particularly FIGS. 26, 28, 29, 31 and 32, this attachment member 460 differs from the attachment member 60 according to the first embodiment in that a crush rib 482 (FIGS. 21, 22, 23, 26 and 29), a crush rib 484 (FIGS. 21, 22, 26 and 32), a crush rib 486 (FIGS. 26 and 28) and a crush rib 488 (FIGS. 26 and 31) are provided on the side of a front surface 70 at four upper, lower, left and right positions of an inner peripheral surface 72. Lengths of these crush ribs are smaller than half the width of the inner peripheral surface 72, and heights thereof are selected to be much smaller than an inner diameter of the opening 64. The crush rib 486 is formed in a recess 78 in the inner peripheral surface 72, and the crush rib 482 is formed in a recess 74 in the inner peripheral surface 72. The crush rib 484, 488 are respectively formed in parts of the inner peripheral surface 72 other than recesses.

The attachment member 460 is the same as the attachment member 60 according to the first embodiment except that these crush ribs are formed.

### 2-2. Fitting Opening 462

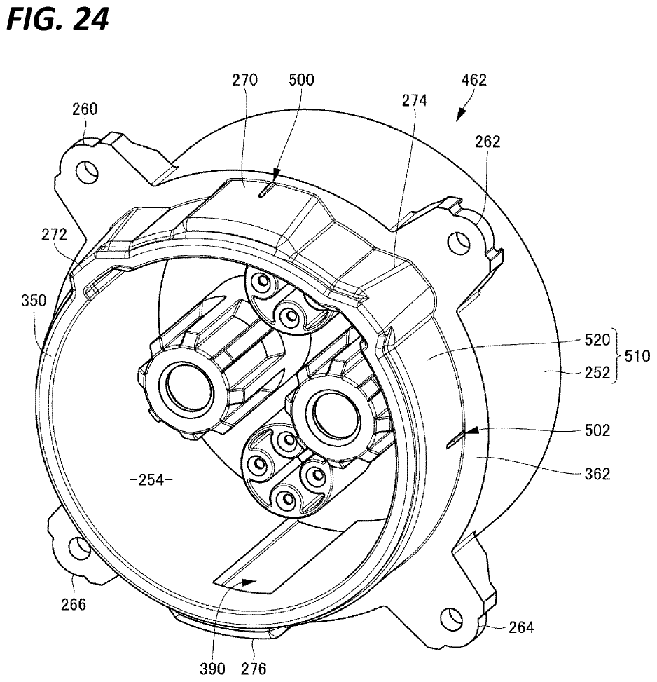

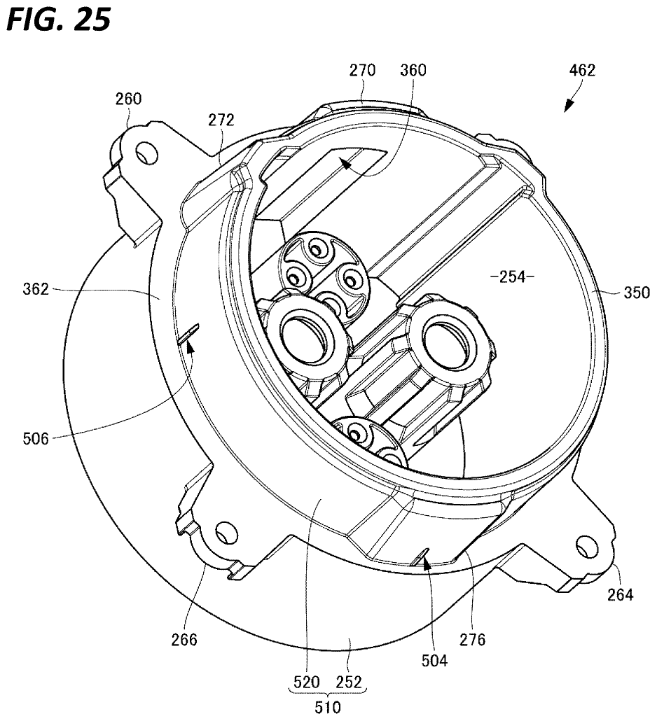

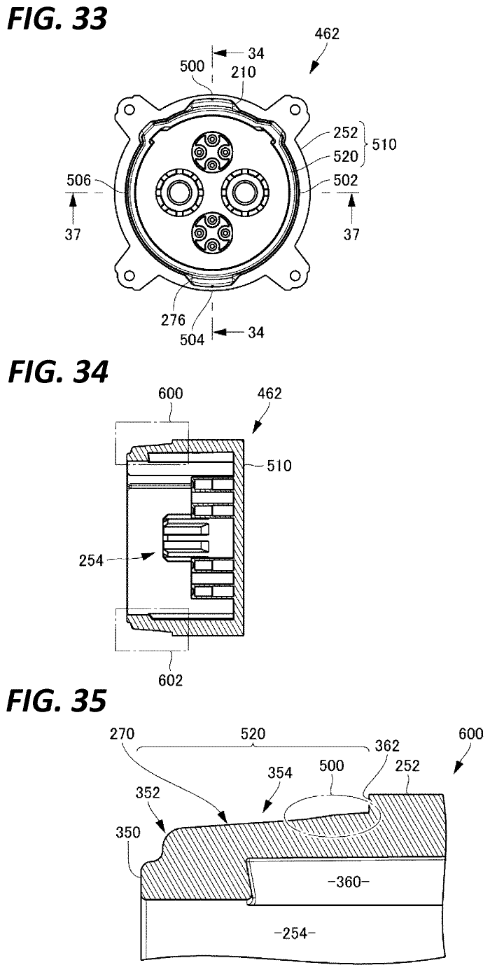

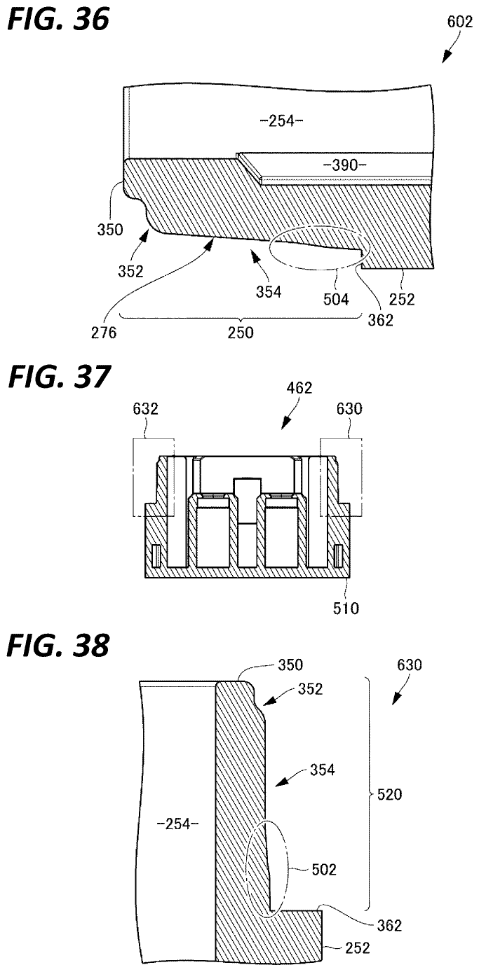

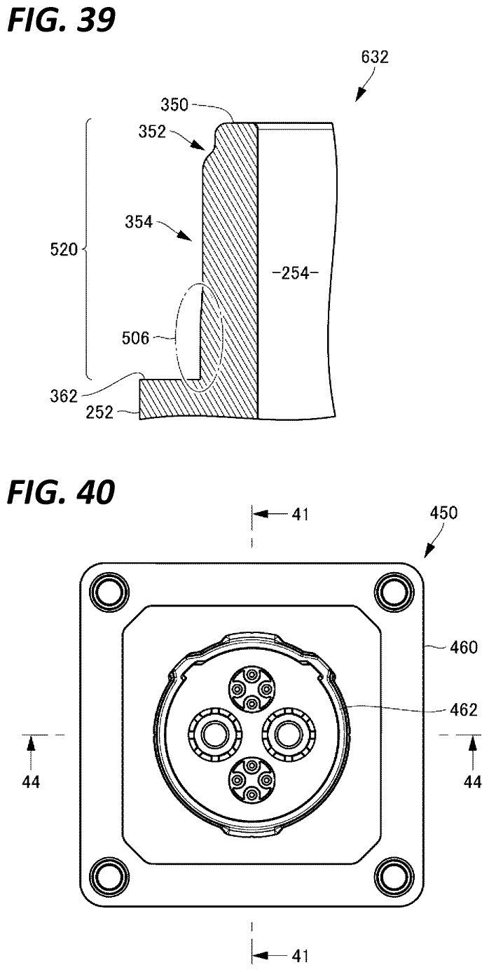

FIGS. 24 and 25 are perspective views of the fitting opening 462 when viewed from angles different from each other. FIG. 33 is a front view of the fitting opening 462. FIG. 34 is a section along 34-34 of FIG. 33. FIG. 35 is an enlarged view of a region 600 of FIG. 34, and FIG. 36 is an enlarged view of a region 602 of FIG. 36. FIG. 37 is a section along 37-37 of FIG. 33. FIG. 38 is an enlarged view of a region 630 of FIG. 37, and FIG. 39 is an enlarged view of a region 632 of FIG. 37.

With reference to FIGS. 24 and 25, the fitting opening 462 includes a housing 510. The housing 510 includes a rear housing 252, which is the same as that of the fitting opening 62 according to the first embodiment, and a fitting portion 520, which is substantially the same as the fitting portion 250 in the first embodiment, provided on a tip side of the rear housing 252.

The fitting portion 520 does not include the step provided in the region 358 on the outer periphery (FIGS. 12 and 13), unlike the fitting portion 250 in the first embodiment. Instead, the fitting portion 520 includes a crush rib 500 (FIGS. 33 and 35), a crush rib 502 (FIGS. 33 and 38), a crush rib 504 (FIGS. 33 and 36) and a crush rib 506 (FIGS. 33 and 39) as shown in FIGS. 33, 35, 36, 8 and 39. These crush ribs are provided at positions respectively facing the four crush rib 486, 488, 482 and 484 provided on the inner peripheral surface 72 of the attachment member 460 when the fitting opening 462 is fit to the attachment member 460. Any of the crush rib 500, 502, 504 and 506 has the same size, a length thereof in a direction parallel to a center axis of the housing 510 is smaller than half the width of the housing 510, and a height thereof is selected to be much smaller than a diameter of the outer periphery of the fitting portion 520. In other points, the fitting opening 462 is the same as the fitting opening 62 of the first embodiment. Typically, when the fitting opening 460 is fit to the attachment member 460, the four crush rib 486, 488, 482 and 484 provided on the inner peripheral surface 72 of the attachment member 460 have the same size as the crush rib 500, 502, 504 and 506. Therefore, when the fitting opening 462 is fit into the opening 64 of the attachment member 460, the crush ribs of the attachment member 460 and those of the fitting opening 462 do not interfere with each other.

### 2-3. During Assembly

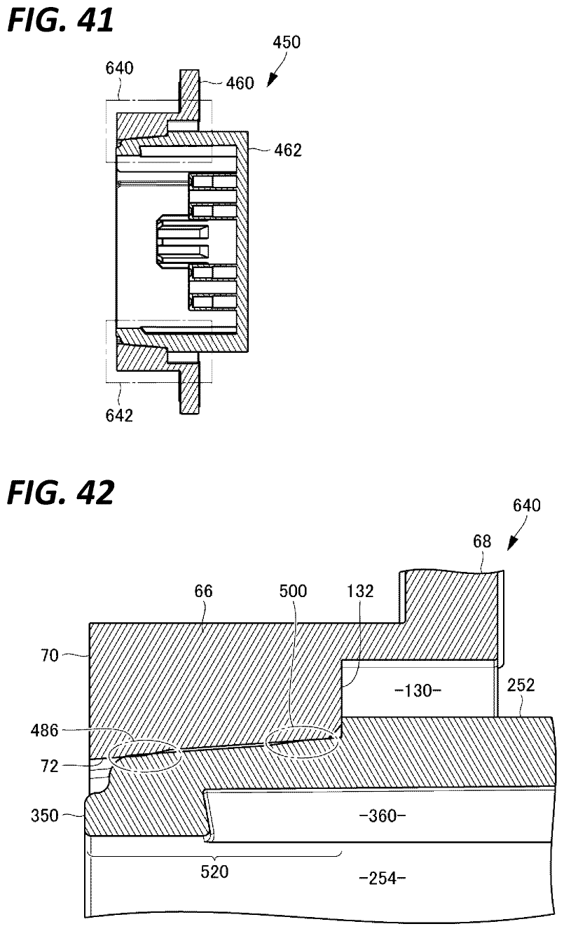

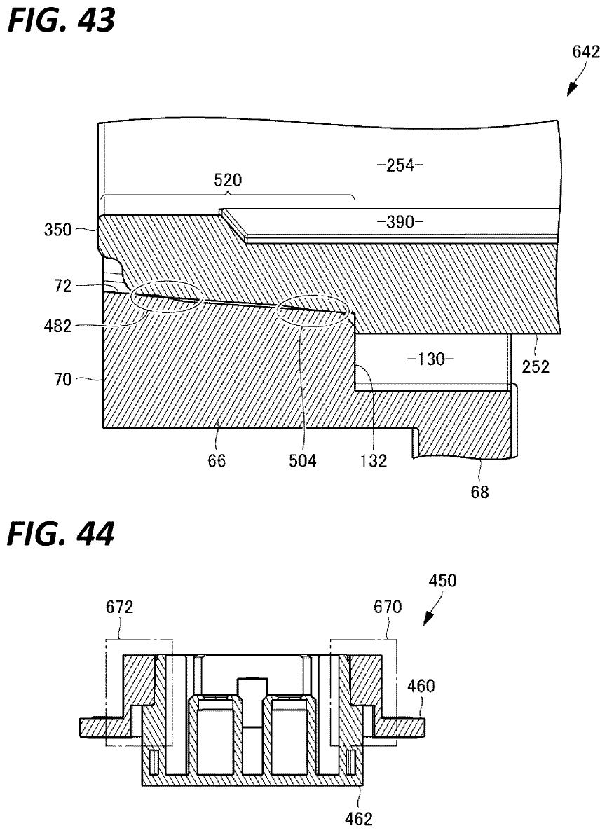

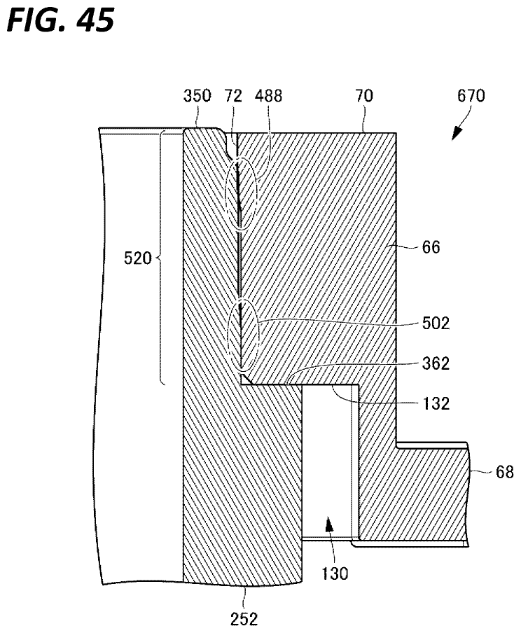

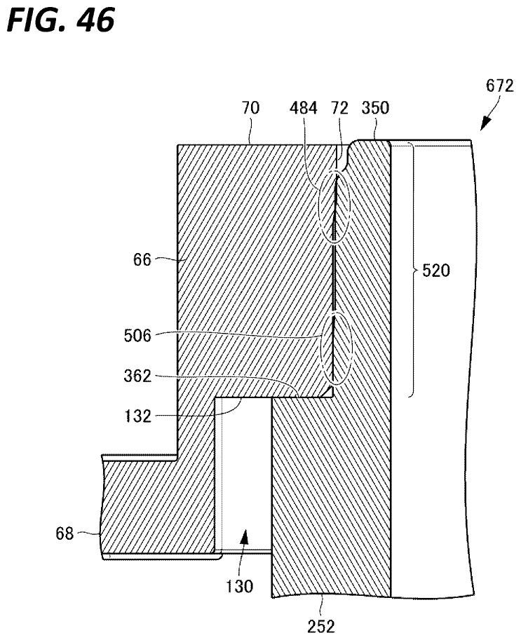

FIG. 40 shows a state where the fitting opening 462 is assembled with the attachment member 460 in the connector 450 according to the second embodiment. FIG. 41 is a section along 41-41 of FIG. 40. FIG. 42 is an enlarged view of a region 640 of FIG. 41, and FIG. 43 is an enlarged view of a region 642 of FIG. 41. FIG. 44 is a section along 43-43 of FIG. 40. FIG. 45 is an enlarged view of a region 670 of FIG. 44, and FIG. 46 is an enlarged view of a region 672 of FIG. 44.

Note that, although not denoted by a reference number in these figures, a chamfered portion 138 is formed in a boundary part between a bottom surface 132 of the attachment member 460 and the opening 64 as in the first embodiment as shown in FIGS. 22, 23, 28, 29, 31 and 32. Therefore, the fitting opening 462 can be easily inserted into the opening 64 of the attachment member 460 and work efficiency is improved.

With reference to FIGS. 40 to 46, particularly FIGS. 42, 43, 45 and 46, if the fitting opening 462 is assembled with the attachment member 460, an outer peripheral part of the fitting portion 520 and the inner peripheral surface 72 of the attachment member 46 contact each other. However, for example, by the crush rib 48 formed on a tip part of the inner peripheral surface 72 and the crush rib 500 formed in a region adjacent to the rear housing 252 of the fitting portion 520, the inner peripheral surface 72 of the opening 64 of the attachment member 460 and the outer peripheral surface of the fitting portion 520 of the fitting opening 462 are held in close contact in parts where these crush ribs are formed as shown in FIG. 42. However, in other regions, tiny gaps are formed between the inner peripheral surface of the opening 64 and the outer peripheral part of the fitting portion 520. Gaps are ensured between the both during insertion, and the crush ribs such as the crush ribs 486, 500 do not contact mating surfaces and workability when the fitting opening 462 is assembled with the attachment member 460 can be ensured until immediately before insertion is completed. Further, when the insertion is completed, the crush ribs such as the crush ribs 486, 500 strongly contact the mating surfaces, whereby the attachment member 460 can firmly hold the fitting opening 462. Further, the fitting opening 462 can be correctly positioned in the opening 64 of the attachment member 460 by these crush ribs. As a result, the attachment member 460 and the fitting opening 462 are reliably assembled while workability is ensured.

Note that, in this embodiment, the crush ribs of the attachment member 460 and those of the fitting opening 462 are arranged at positions to face each other when the fitting opening 462 is fit to the attachment member 460. However, this disclosure is not limited to such an embodiment. The crush ribs can also be arranged at positions not to face each other during connection. In that case, the sizes of the crush ribs need not be limited. However, in terms of ensuring workability, it is better to avoid making the crush ribs larger.

Further, in this embodiment, the crush ribs of the attachment member 460 and those of the fitting opening 462 are all provided at upper, lower, left and right positions when viewed from the front of the connector 450 at the time of mounting the connector 450 in a vehicle. That is, these crush ribs are arranged at line symmetrical positions with respect to an axis in the vertical direction passing through a center of the front surface of the connector 450. Further, these crush ribs are also arranged at line symmetrical positions with respect to an axis in the lateral direction passing through the front surface of the connector 450. Furthermore, these crush ribs are arranged at four rotationally symmetrical positions with respect to a center point of the front surface of the connector 450. By arranging the crush ribs in this way, the following effects are produced.

That is, during charging, illumination may be turned on inside the connector 450 to indicate that charging is in progress. In that case, that light leaking forward is seen through gaps formed in regions other than those where the crush ribs are present between the inner peripheral surface 72 of the opening 64 and the outer periphery of the fitting portion 520. Thus, an aesthetic effect that a tip part of the fitting opening 462 looks to be lifted up from a surrounding is obtained. At this time, since the crush ribs are arranged as described above, rays of light leaking out when viewed from front are bilaterally symmetrical and intervals therebetween are equal to each other. Therefore, there is an effect that the tip part of the fitting opening 462 lifted up by light looks good. Of course, a similar aesthetic effect is obtained, for example, even if the crush ribs are arranged symmetrically only in the vertical direction, but not in the lateral direction, or arranged symmetrically only in the lateral direction, but not in the vertical direction.

Further, in the above embodiment, both the attachment member 460 and the fitting opening 462 are formed with four crush ribs. However, this disclosure is not limited to such an embodiment. The numbers of the crush ribs of the both may be different from each other. The number of the crush ribs may not be four, but may be three, five or more. However, since the crush ribs have a function of positioning the fitting opening 462 as described above, the number of the crush ribs is desirably three or more in both the attachment member 460 and the fitting opening 462.

Projections of a proper size provided at proper positions may be other than the crush ribs. For example, those projections may be ribs other than the crush ribs.

The embodiments disclosed this time should be considered illustrative in all aspects, rather than restrictive. The scope of the present disclosure is not represented by the detailed description of the present disclosure, but is represented by claims and intended to include all changes in the meaning and scope of literal equivalents to claims.

### LIST OF REFERENCE NUMERALS

50, 450 connector
60, 460 attachment member
62, 462 fitting opening
64, 130 opening
66 panel portion
68 flange
70, 90 front surface
72 inner peripheral surface
74, 76, 78, 80 recess
82, 84, 86, 88 attachment hole
132 bottom surface
134, 354 side surface
138 chamfered portion
140, 142, 144, 146 screw hole
148 back surface
180, 182, 300, 302, 358, 430, 432, 530, 532, 560, 562, 600, 602, 630, 632, 640, 642, 670, 672 region
240, 510 housing
250, 520 fitting portion
252 rear housing
254, 360, 390 space
260, 262, 264, 266 protruding portion
270, 272, 274, 276 protrusion
350 tip surface
352 tip part side surface
362 contact surface
482, 484, 486, 488, 500, 502, 504, 506 crush rib

1. A connector, comprising:
a fitting opening for charging; and
an attachment portion for attaching the fitting opening to a vehicle,
the attachment portion including:
a panel portion having a first surface and a second surface, the panel portion being formed with an opening between the first and second surfaces; and
a flange portion having an attachment tool for attaching the panel portion to the vehicle, the flange portion being formed around the panel portion,
the fitting opening including a tubular housing including a terminal group for charging inside, and
the housing including a contact portion for contacting a peripheral edge part of the opening on the second surface side such that a tip of the housing is in a predetermined positional relationship with the first surface when the housing is fit into the opening from the second surface side.

2. The connector of claim 1, wherein the peripheral edge part of the opening on the second surface side is chamfered in the panel portion.

3. The connector of claim 1, wherein a predetermined region adjacent to the contact portion from the tip side of the housing is formed to have a taper larger than a taper from the predetermined region to the tip of the housing on an outer peripheral surface of the housing.

4. The connector of claim 1, wherein a step is formed at a position separated from the contact portion toward the tip side by a predetermined distance on an outer peripheral surface of the housing.

5. The connector of claim 3, wherein an inner periphery of the opening in the panel portion is shaped to have such a taper that an inner diameter of the opening increases from the first surface toward the predetermined region.

6. The connector of claim 1, further comprising three or more housing-side crush ribs formed in a predetermined region extending from the tip side of the housing and in contact with the contact portion on an outer periphery surface of the housing.

7. The connector of claim 6, comprising four or more of the housing-side crush ribs.

8. The connector of claim 6, wherein:
the housing has a center axis in a direction coinciding with an insertion direction of the housing into the opening, and
the three or more housing-side crush ribs are formed at rotationally symmetrical positions with respect to the center axis.

9. The connector of claim 6, wherein the three or more housing-side crush ribs are formed at line symmetrical positions.

10. The connector of claim 1, further comprising three or more panel-side crush ribs formed in a region closer to the first surface than the second surface on an inner peripheral surface of the opening of the panel portion.

11. The connector of claim 10, comprising four or more of the panel-side crush ribs.

12. The connector of claim 10, wherein:
the housing has a center axis in a direction coinciding with an insertion direction of the housing into the opening, and
the three or more panel-side crush ribs are formed at rotationally symmetrical positions with respect to the center axis of the housing when the housing is fit into the opening.

13. The connector of claim 10, wherein the three or more panel-side crush ribs are formed at line symmetrical positions.

14. The connector of claim 1, further comprising:
three or more housing-side crush ribs formed in a predetermined region extending from the tip side of the housing and in contact with the contact portion on an outer peripheral surface of the housing; and
three or more panel-side crush ribs formed in a region closer to the first surface than the second surface on an inner peripheral surface of the opening of the panel portion,
at least one of the three or more housing-side crush ribs and at least one of the three or more panel-side crush ribs are formed at positions not to interfere with each other so that these crush ribs are opposed to each other when the fitting opening is fit into the opening.

15. A fitting opening as a component of a connector to be attached to a vehicle, the connector including the fitting opening and an attachment portion for attaching the fitting opening to the vehicle, the attachment portion including a panel portion having a first surface and a second surface, the panel portion being formed with an opening between the first and second surfaces, and a flange portion having an attachment tool for attaching the panel portion to the vehicle, the flange portion being formed around the panel portion, the fitting opening comprising a tubular housing including a terminal group for charging inside, the housing including a contact portion for contacting a peripheral edge part of the opening on the second surface side such that a tip of the housing is in a predetermined positional relationship with the first surface when the housing is fit into the opening from the second surface side, and
a predetermined region adjacent to the contact portion from the tip side of the housing being formed to have a taper larger than a taper from the predetermined region to the tip of the housing on an outer peripheral surface of the housing.

16. An attachment member for attaching a fitting opening for charging to a vehicle, comprising:
a panel portion having a first surface and a second surface, the panel portion being formed with an opening between the first and second surfaces; and
a flange portion having an attachment tool for attaching the panel portion to the vehicle, the flange portion being formed around the panel portion,
a peripheral edge part of the opening on the second surface side being chamfered in the panel portion.
